(19) United States
(12) Patent Application Publication
(10) Pub. No.: US 2026/0105784 A1
(43) Pub. Date: Apr. 16, 2026

(54) EQUIPMENT ANALYSIS, MAINTENANCE MONITORING, OPERATOR TRAINING AND FLEET MANAGEMENT

(71) Applicant: Caterpillar Inc., Peoria, IL (US)

(72) Inventors: Yanchai Zhang, Dunlap, IL (US); Cheng Yu, Edwards, IL (US); Xuefei Hu, Dunlap, IL (US); Zhiyong Hu, Chicago, IL (US); Anand Balasubramanian, Peoria, IL (US)

(73) Assignee: Caterpillar Inc., Peoria, IL (US)

(21) Appl. No.: 18/916,525

(22) Filed: Oct. 15, 2024

(51) Int. Cl. G07C 5/00; G07C 5/08

(52) U.S. Cl. CPC G07C 5/008; G07C 5/0808; G07C 5/0825

(57) ABSTRACT

Generation of a reduced order model (ROM)-based digital twin and presentation of an equipment system, subsystem or component using augmented reality, mixed reality or virtual reality is provided. Leveraging digital twin generation, artificial intelligence and machine learning analytics, and immersive augmented reality, mixed reality or virtual reality experiences enables a more realistic virtual maintenance and training environment. A reduced order model (ROM) may be generated for each component of a work machine. After generation of an initial ROM model and/or after enhancement or tuning of the initial ROM model with real-time information, a digital twin of the work machine and its components may be generated. An augmented reality (AR), mixed reality (MR) or virtual reality (VR) rendering may be generated from the digital twin for the work machine and for each of its included components.

### TECHNICAL FIELD

The present disclosure generally relates to equipment analysis, maintenance monitoring, operator training, and fleet management. More particularly, the present disclosure relates to generation of digital twins of equipment components and use of augmented reality, mixed reality and/or virtual reality for equipment analysis, maintenance monitoring, operator training, and fleet management.

### BACKGROUND

Modern machines such as vehicles of various types include a variety of machine systems, subsystems, and individual components, for example, engines, motors, transmission systems, braking systems, steering systems, hydraulic systems, pneumatic systems, and the like. Systems, subsystems and/or components are often embedded inside a given equipment part or component making inspection and/or maintenance difficult and time-consuming. For example, components of a brake assembly of an earthmoving machine, such as a bulldozer, front-end loader, skid steer, or a road or rail vehicle such as an automobile, trailer tractor, locomotive, and the like are typically located inside an enclosed brake assembly or behind wheel assemblies, or track assemblies. For another example, components of a machine engine, motor, or transmission system are typically enclosed inside an engine/motor assembly or compartment.

Unfortunately, for purposes of periodic maintenance or for repairing a failing or failed component of such systems, maintenance personnel must open, uncover, disassemble, or otherwise “tear down” such systems to analyze and possibly repair a potential problem and/or to provide periodic required maintenance. For example, if an equipment operator or maintenance person detects an issue with a vehicle brake assembly owing to a noise or for a performance problem, personnel may be required to remove a wheel or track assembly, disassemble covers encasing the example brake assembly and/or completely tear down or disassemble the braking system in order to determine the need for a repair or other maintenance action.

In addition to system analysis and maintenance, operator training is important because a given operator may be utilizing a piece of equipment in a manner (e.g., speed, acceleration, braking, etc.) that leads to system, subsystem and/or component damage or failure. The above-mentioned difficulties associated with system analysis and maintenance similarly make it difficult to train operators because often a system, subsystem or component failure may occur without information to alert an operator as to causes or potential causes of the failure related to operator performance.

An example system and method for generating a digital twin of a vehicle (e.g., a recreational vehicle) is described in U.S. patent application 20230074139A1 to Ghosh et al., filed Sep. 3, 2021, by applicant International Business Machines Corporation titled “Proactive Maintenance for Smart Vehicle” (hereafter “the '139 document”). In particular, the '139 document describes using an input data set associated with a plurality of vehicle components and one or more vehicle performance factors to produce a digital twin of the vehicle.

Although the '139 document describes generating a digital twin of a recreational vehicle and using the digital twin to inspect or predict the impact of operating conditions on the vehicle, the methods and systems described in the '139 document are computationally expensive and require significant data and computing resources. Moreover, the methods and systems of the '139 document do not provide for adequate interactive use of digital twins associated with a vehicle, machine, or other type of equipment.

Examples of the present disclosure are directed to overcoming the deficiencies described above.

### SUMMARY OF THE INVENTION

Systems and methods are provided for reduced order model (ROM)-based generation of digital twins and augmented reality renderings for components of a work machine. A method includes receiving system data from a work machine and passing the system data to a reduced order model system. At the reduced order model system, a reduced order model is generated for the work machine. The reduced order model for the work machine is passed to a digital twin model system. At the digital twin model system, a digital twin is generated for the work machine. According to examples, an augmented reality rendering of a component of the work machine is generated from the digital twin. Selection of the augmented reality rendering may cause generation of an augmented reality rendering of a subcomponent of the component of the work machine. According to examples of the present disclosure, a health indicator may be applied to a feature of the augmented reality rendering. The health indicator may include color-coding the feature of the augmented reality rendering.

Prior to generating from the digital twin an augmented reality rendering of a component of the work machine, a request may be received for an augmented reality rendering of the component of the work machine. The request may include receiving a scanned or entered identification of the component of the work machine. In response to receiving a request for an augmented reality rendering of the component of the work machine, the augmented reality rendering of the component of the work machine may be displayed on a computing device.

If system data or operating conditions data for the work machine changes, the ROM model for the work machine may be updated. In response, the digital twin and augmented reality rendering also may be updated. Operating conditions data for the work machine also may be passed to a machine learning model for training the machine learning model. Information (learnings) from the machine learning model may be used to update or tune the ROM model for the work machine.

According to another example, a system is provided. The system may include a work machine having an electronic control module configured to pass system data and real time operating conditions data for the work machine to a reduced order model system. The reduced order model system is configured to generate a reduced order model for the work machine based at least in part on the system data and real time operating conditions data for the work machine. The reduced order model system is further configured to pass the reduced order model for the work machine to a digital twin model system. The digital twin model system configured to generate a digital twin for the work machine based at least in part on the system data and real time operating conditions data for the work machine. An augmented reality system is configured to generate from the digital twin an augmented reality rendering of a component of the work machine.

According to another example, a method is provided and includes transmitting system data and operating conditions data from a work machine to a cloud-based analysis system. At the cloud-based analysis system, the system data and the operating conditions data are passed to a reduced order model system. At the reduced order model system, a reduced order model is generated for the work machine. At the cloud-based analysis system, the reduced order model for the work machine is passed to a digital twin model system. At the digital twin model system, a digital twin for the work machine is generated. At the cloud-based analysis system, the digital twin for the work machine is passed to an augmented reality system. At the augmented reality system, an augmented reality rendering of the work machine is generated from the digital twin.

The augmented reality rendering of the work machine and real time insights may be transmitted to a remote support and collaboration system for determining maintenance requirements for the work machine based at least in part on the augmented reality rendering of the work machine and the real time insights. In addition, the augmented reality rendering of the work machine and the real time insights may be transmitted to an immersive training system for training work machine operations based at least in part on the augmented reality rendering of the work machine and the real time insights.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a system for generation of a reduced order model (ROM)-based digital twin and presentation of an example equipment system, subsystem or component using augmented reality, mixed reality or virtual reality, according to examples of the present disclosure.

FIG. 2 illustrates a system for generating a ROM-based digital twin of an equipment system, subsystem, or component and for utilizing augmented reality, mixed reality, or virtual reality for providing review of and interaction with a presentation of an equipment system, subsystem, or component, according to examples of the present disclosure.

FIG. 3 illustrates an architecture for utilization of a ROM-based digital twin, according to examples of the present disclosure.

FIG. 4 illustrates a system and method for utilization of a ROM-based digital twin of an equipment system, subsystem, or component for immersive operator training, according to examples of the present disclosure.

FIG. 5 illustrates utilization of a ROM-based digital twin for equipment operation review and analysis, according to examples of the present disclosure.

FIG. 6 illustrates a flow diagram of an example method for generation and utilization of a ROM-based digital twin of an equipment system, subsystem, or component, according to examples of the present disclosure.

FIG. 7 illustrates a computer architecture diagram showing illustrative hardware architecture for implementing aspects of various technologies of the present disclosure.

### DETAILED DESCRIPTION

Wherever possible, the same reference numbers will be used throughout the figures to refer to the same or like parts. In the figures, the left-most digit(s) of a reference number identifies the figure in which the reference number first appears.

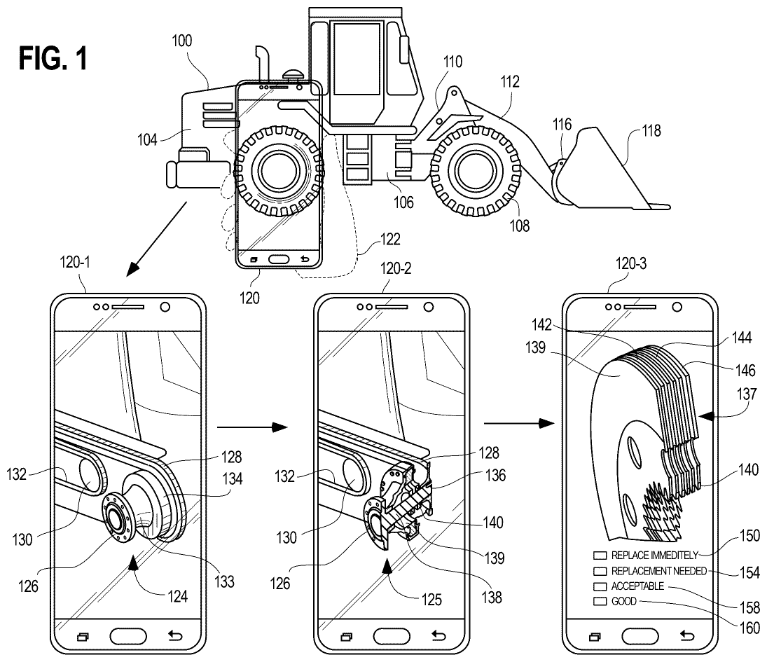

FIG. 1 illustrates a system for generation of a reduced order model (ROM)-based digital twin and presentation of an example equipment system, subsystem or component using augmented reality, mixed reality or virtual reality, according to examples of the present disclosure. As will be described in detail below, a reduced order model (ROM) may be generated for each component or selected components of a work machine 100. The ROM model may be initially generated based on specifications of the work machine 100 including detailed information on each component of the work machine 100. The initially generated ROM model may be enhanced by feeding the ROM model real-time component data such as received from internal sensors associated with work machine components and by feeding the ROM model with real-time operating conditions such as work machine speed, acceleration, deceleration, braking, work machine loading data, work machine operating terrain, work machine material handling information, as well as environmental conditions such as temperature, wind velocity, moisture presence, and the like. Information used for enhancing or tuning an initially generated ROM model may be fed directly to the ROM model or may be processed by a machine learning and artificial intelligence system that, in turn, may feed information to enhance the ROM model to a ROM model system.

According to examples, after generation of an initial ROM model and/or after enhancement or tuning of the initial ROM model with real-time information, a digital twin of the work machine and its components may be generated. An augmented reality (AR), mixed reality (MR) or virtual reality (VR) (hereafter “AR/MR/VR”) rendering may be generated for the work machine 100 and for each of its included components. According to examples, operators of the work machine 100, operator training personnel, maintenance personnel, and/or fleet management personnel may utilize the AR/MR/VR renderings of the components of the work machine 100 for determining problems with components of the work machine 100, for predicting future problems with components of the work machine 100, for training operators of the work machine 100, for assisting maintenance personnel, and for assisting in management of work machine fleets.

As understood by the understood by those skilled in the art, augmented reality (AR) is an interactive experience that combines digital information with real world information to enhance a user's perception of reality. The content of an augmented reality environment includes parts of a surrounding environment, for example, the physical components of the work machine 100 that are real, and the augmented reality adds layers of virtual objects to the real environment. AR may be experienced using a variety of systems, for example, smart phones, such as the handheld device 120 illustrated in FIG. 1, tablets, smart glasses and headsets for overlaying digital content over real world content to provide an interactive experience as illustrated in FIG. 1. On the other hand, with virtual reality (VR). Mixed reality (MR) merges real world environments with computer-generated content. According to examples of the present disclosure AR, MR and VR renderings may be utilized for providing an interactive and immersive environment for review of components of the work machine 100.

As illustrated in FIG. 1, a work machine 100 is provided with which various types of work, for example, earthmoving, material moving, and the like may be performed. The work machine 100 illustrates a typical front-end loader with which material such as dirt, rock, concrete, wood, steel, and the like may be moved from one location to another or may be loaded onto or unloaded from a transport, such as a truck or trailer. The work machine 100, illustrated in FIG. 1, is for purposes of example only and is not limiting of other types of work machines that may be utilized according to examples of the present disclosure. For example, the work machine 100 may include a bulldozer, skid steer, tractor, large-scale earthmoving machine, and the like. In addition, as will be appreciated, examples of the present disclosure may be utilized with other types of vehicles, including but not limited to aircraft, automobiles, trucks, trailers, as well as any type of non-vehicle machine, and the like.

Referring still to FIG. 1, the work machine 100 includes a cab in which an operator controls the work machine 100. The engine compartment 104 includes space for a combustion engine, hybrid combustion/electric engine/motor combination, or an electric motor system for a fully electric work machine 100. An under-cab section 106 is provided in which various systems such as transmissions, cabin cooling systems, and the like may be maintained. As will be described below, the under-cab section 106 also may include various control systems available for operation of the work machine 100. Wheel and tire assemblies 108 are provided for moving the work machine 100. As should be appreciated, other types of movement systems such as track systems also may be used for moving the work machine 100.

Forward of the cab 102 are components required for movement and use of a work tool attached to the work machine 100. Push arm mounts 110 are provided to which are attached one or more push arms 112. According to examples, the push arms 112 may articulate relative to the push arm mounts to raise or lower an attached work tool as required for picking up, dropping and/or pushing material. According to examples, the push arms 112 may articulate relative to the push arm mounts 110 via a suitable motion system, such as a hydraulic or pneumatic cylinder system.

At a forward end of the push arms 112, a work tool coupler 116 is provided for attaching a work tool 118 to the push arms 112. According to examples, the work tool 118 is illustrative of a number of different work tools that may be attached to the work machine 100 via the work tool coupler 116. For example, the work tool 118 illustrated in FIG. 1 is a bucket with which material may be pushed, scooped, lifted, dumped, and the like. Other types of work tools 118 may include blades for pushing material, forks for lifting material such as pallets, and the like. Different types of work tools 118 that may be utilized with the work machine 100 are well known to those skilled in the art. As should be appreciated, the configuration of components of the work machine 100, illustrated in FIG. 1, is for purposes of illustration an example only. That is, according to other types and sizes of work machines 100, the engine compartment may be forward of the cab, work tools may be attached to a rear push arm or lifting arm, and the like.

Referring still to FIG. 1, according to examples of the present disclosure, a work machine operator, training person, maintenance person, fleet management person, and the like may interact with the work machine 100 for reviewing components of the work machine 100 for which a ROM model, digital twin, and associated AR/MR/VR renderings have been generated. According to examples, the AR/MR/VR renderings of a given component of the work machine 100 may be provided according to a number of methods. For example, a computing device, such as a phone, tablet, laptop computer, desktop computer, or the like may be used to enter or scan a serial number, barcode or similar identification for the work machine 100 or for a given component of the work machine 100.

According to one example, prior to receiving the AR/MR/VR renderings, a request is received for provision of the AR/MR/VR renderings by scanning or entering an identification for the work machine 100 or one or more of its components. Scanning or entering an identification for the work machine 100 may provide a listing of components of the work machine 100 for which a ROM model, digital twin and associated AR/MR/VR renderings are available. For example, a listing of such components may include engine components, transmission components, axle and brake assemblies, wheel and tire assemblies, hydraulic systems, pneumatic systems, electrical systems, material handling systems, and the like. As should be appreciated, the foregoing listing of components is provided for purposes of example and is not list limiting of many additional components including subsystems or subcomponents of such components for which a ROM model, digital twin and associated AR/MR/VR renderings may be generated according to examples of the present disclosure. After a listing of components for which a ROM model, digital twin and associated AR/MR/VR renderings are available, the user may select a given component for review as described herein.

Alternatively, the user may scan or enter an identification for a particular work machine component by scanning a serial number, barcode, or other similar identification for the component. For example, a barcode or other identification may be provided on a covering of the engine compartment 104 for receiving AR/MR/VR renderings of the engine or motor contained inside the engine compartment 104. Alternatively, the user may open the engine compartment 104 and scan or enter an identification for one or more components of the work machine engine or motor, for example, cooling systems, exhaust systems, fuel systems, electrical systems, and the like. According to examples, identifications may be scanned or entered for any component of the work machine 100 for which a ROM model, digital twin and AR/MR/VR renderings are available.

After a given component is selected for review, an AR/MR/VR rendering for the given component may be displayed on the user's computing device, as illustrated in FIG. 1. According to examples, instead of scanning or entering an identification using a handheld device 120 or other appropriate computing device, as illustrated in FIG. 1, an identification for a given work machine 100 or for a given component of the work machine 100 may be entered at a remote computing device, and the AR/MR/VR renderings may be provided at the remote computing device for review by personnel positioned remotely from the work machine 100.

Referring still to FIG. 1, an example component review is illustrated in which a user (e.g., a work machine operator, training person, maintenance person, fleet management person, or the like) is interested in reviewing a work machine component for inspection, maintenance, training, or fleet management. According to the example illustrated in FIG. 1, the component selected for review includes an axle and brake assembly for the example work machine 100. As illustrated in FIG. 1, the user 122 utilizes a handheld device 120 to scan a wheel and tire assembly 108 of the example work machine 100 for purposes of reviewing components of the wheel and tire assembly 108 or for other components associated with or underlying the wheel and tire assembly 108. According to the example illustrated in FIG. 1, the user 122 is interested in reviewing an axle and brake assembly 126 operating in association with the wheel and tire assembly 108.

According to the illustrated example, the user 122 may scan an identifier (e.g., a barcode or serial number) provided on the wheel and tire assembly, or as described above, the user 122 may select the desired axle and brake assembly 126 from a listing of components of the work machine 100 provided by scanning or entering an identification for the work machine 100. According to examples, the user 122 may desire a review of the subject axle and brake assembly for a number of reasons. As should be appreciated, description of an axle and brake assembly is for purposes of example only and is not limiting of the many components of the work machine 100 that may be selected for review.

According to one example, the user 122 may be an operator of the work machine 100 who detects an abnormal sound or noise, such as a squeak, coming from the axle and brake assembly during braking of the work machine 100. For another example, the user 122 may be a maintenance person desiring to inspect the axle and brake assembly owing to a reported problem with the axle and brake assembly or owing to a scheduled inspection of the axle and brake assembly. For another example, the user 122 may be a training person desiring to review the axle and brake assembly for training an operator of the work machine 100 on operating the work machine 100 according to best practices associated with braking movement of the work machine 100. Alternatively, the training person may want to review the axle and brake assembly for training maintenance personnel or fleet management personnel about aspects of the brake assembly of the subject axle and brake assembly. For still another example, fleet management personnel may want to review the axle and brake assembly for determining the current operating life of one or more components of the axle and brake assembly for determining whether the example work machine 100 is available for use for a given period before maintenance of the axle and brake assembly will be required.

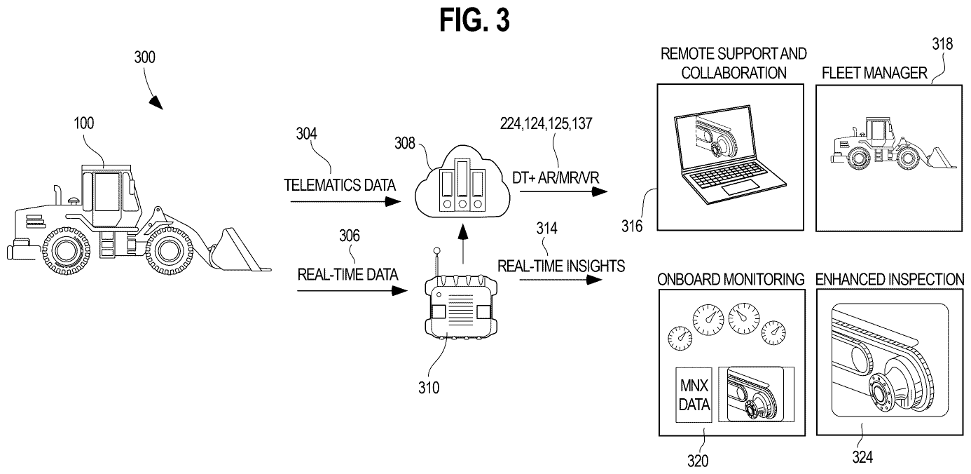

Referring still to FIG. 1, according to the illustrated example, in response to entering or scanning an identification for the axle and brake assembly 126 located in association with the right rear wheel and tire assembly 108 of the example work machine 100, an AR/MR/VR rendering 124 of the axle and brake assembly 126 is displayed on the user's handheld device view 120-1. As discussed above, according to an alternate example, the AR/MR/VR rendering 124 of the axle and brake assembly 126 may be displayed on a computing device display screen operating remotely from the work machine 100 where, for example, a user enters or scans an identification for the subject axle and brake assembly 126 at a remote location such as a maintenance facility. In such a case, data representing the axle and brake assembly 126 may be passed to the remote location via any suitable transmission means, such as wireless transmission from the work machine 100 to the remote facility as illustrated and described below with reference to FIG. 3.

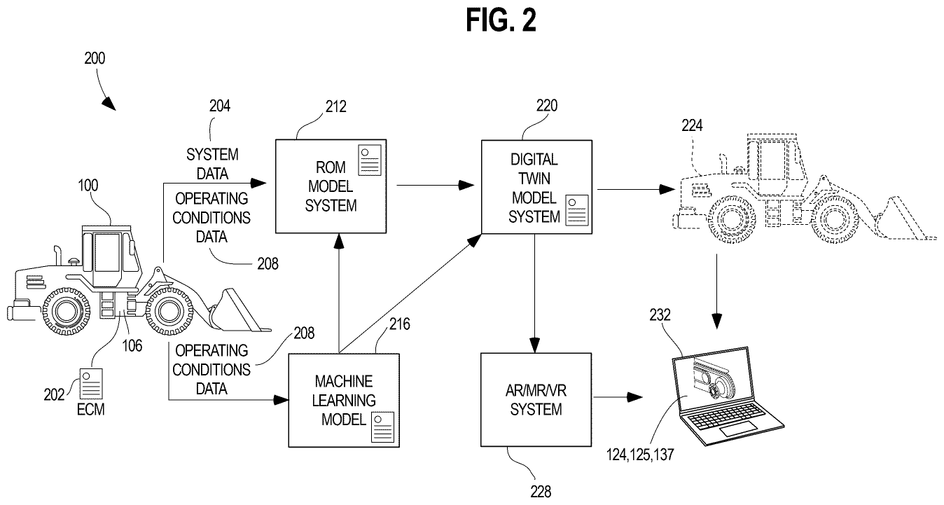

Referring to the example handheld device view 120-1, the AR/MR/VR rendering 124 of the axle and brake assembly 126 is illustrated showing one or more components of the axle and brake assembly 126. For example, a brake caliper and brake pads cover 134 is illustrated. A chain or belt assembly 128 is illustrated for transferring power from an axle 138 to other components of the work machine 100. A secondary wheel or sprocket 130 and belt or chain assembly 132 is illustrated separate from the axle and brake assembly 126. As described below with reference to FIG. 2, the AR/MR/VR rendering 124 may illustrate a subset of components of the axle and brake assembly 126. That is, based on a ROM model for the example axle and brake assembly, a subset of the components of the axle and brake assembly 126 are modeled for generation of a digital twin of the work machine 100 and its various components such that only those components or subset of components determined necessary for AR/MR/VR rendering are included in the ROM model.

Referring still to the example handheld device view 120-1, the AR/MR/VR rendering 124 may use color-coding or other suitable means for highlighting rendered components in terms of the health of rendered components. For example, a component that is damaged or worn beyond useful life may be color-coded in red. A component that is still in working order but that should be replaced may be color-coded in amber or orange. A component that is somewhat worn but is acceptable for continued use may be color-coded yellow, and a component that is in good working condition may be color-coded in green. As should be appreciated, these example color codes are for purposes of example only and are not limiting of other methods that may be used for identifying the health of components in an AR/MR/VR rendering. For example, instead of color-coding, hatch lines of various styles may be applied to AR/MR/VR renderings to illustrate health, text-based health descriptions may be displayed for different components, and the like.

According to examples, the health condition of and data for components illustrated in the displayed AR/MR/VR renderings may be based on one or more factors. According to one example, the health of the given component and associated color-coding or other health indicator may be based on the lifespan of or length of service of the component. For example, a manufacturer's suggested lifespan for a given component may dictate color-coding or other component health indicator. For example, if a component such as the chain or belt assembly 128 is considered well within its useful life based on the date of installation in the work machine 100, the chain or belt assembly 128 may be color coded or otherwise identified as good resulting in a color-coding (e.g., green) or similar indicator in the AR/MR/VR renderings. On the other hand, if the example chain or belt assembly 128 is nearing an end of the lifespan during which it is considered in “good” health, the color-coding or other health indicator may change to “acceptable,” and the color-coding or other health indicator may be changed accordingly (e.g., a color-coding of yellow). Likewise, if the example chain or belt assembly 128 is beyond the manufacturer's suggested life span for the assembly, the color-coding or other health indicator may be rendered accordingly (e.g., a color-coding of red or other appropriate health indicator).

Alternatively, the health of various components of the work machine 100 may be determined based on sensors that detect component health. For example, a sensor may detect fluid pressure in a hydraulic line, a sensor may detect air pressure in a tire, a sensor may detect thickness of a brake pad, and the like. As appreciated by those skilled in the art, many sensors and sensor systems are available and may be used to indicate a status or health of a given component of the work machine 100. According to examples of the present disclosure, sensor data for work machine 100 components may be used to dictate color-coding or other health indicators used in the AR/MR/VR renderings 124 displayed to the user 122. For example, if a sensor indicates that the fluid pressure in a hydraulic line is below an acceptable level, AR/MR/VR renderings of the example hydraulic line may be color coded as “red” or may provide another health indicator to alert the user 122 that the example hydraulic fluid pressure must be addressed.

According to one example, information may be displayed along with the AR/MR/VR renderings informing personnel about the health of rendered components or features. For example, a text statement 150 may be provided in association with a color-coding or other health indicator that a component should be replaced immediately. A text statement 154 may be provided in association with a color-coding or other health indicator that replacement of a component is needed. A text statement 158 may be provided in association with a color-coding or other health indicator that an associated component is acceptable and not requiring replacement. A text statement 160 may be provided in association with a color-coding or other health indicator that the health of an associated component is good and not requiring additional maintenance action. According to examples, text statements, as described herein, may be provided to match color-coding or other health indicators. That is, if length of service of a component or sensor data for a component (e.g., time of service or sensed thickness of a brake pad) indicates the component should be changed immediately, then a text statement 150 stating that the component should be replaced immediately may be presented.

Referring still to FIG. 1, according to examples, the AR/MR/VR rendering 124 is an interactive rendering that allows the user 122 to review additional features of a given component. That is, according to examples, the user may “drill down” into a rendered component to internal features of the rendered component. According to one example, the user 122 may touch or otherwise select a feature illustrated in an AR/MR/VR rendering 124 for displaying a different AR/MR/VR rendering that shows additional features of the selected component. As should be appreciated, the examples of components and features of the work machine 100 illustrated in FIG. 1 are for purposes of example only and are not limiting of implementation of examples of the present disclosure for any other component or feature of the work machine 100.

As illustrated in FIG. 1, in response to a selection of a given component, for example, the axle and brake assembly cover 134 in the AR/MR/VR rendering 124 of the handheld device view 120-1, a second rendering 125 may be displayed in the handheld device view 120-2 showing internal components of the axle and brake assembly 126. In the AR/MR/VR rendering 125 illustrated in the handheld device view 120-2, internal features or components of the axle and brake assembly 126 are displayed. As should be appreciated, if the user 122 determines from the AR/MR/VR rendering 124, illustrated in the handheld device view 120-1, that a potential problem may lie in an internal feature or component of the axle and brake assembly 126, for example, where the axle and brake assembly 126 is color coded or otherwise indicated as a potential problem, the user 122 may select the identified component or feature to provide an AR/MR/VR rendering of one or more internal components or features currently out of view under the axle and brake assembly cover 134. That is, according to examples, if an internal component that is hidden from view, for example, a brake pad inside the brake caliper and brake pads cover 134, a color-coding or other health indicator may be applied to the example brake caliper and brake pads cover 134 to alert the user that the possible problem exists with a component such as a brake pad internal to the example brake caliper and brake pads cover 134. Thus, the user will know to select the component that has the color-coding or other health indicator to receive a view of components that are presently covered from view.

Referring still to the AR/MR/VR rendering 125 displayed on the handheld device view 120-2, a cross-section view of an axle 138 is provided, and a cross-section view of a set of brake pads 139 and associated brake caliper 136 is provided. Once the updated AR/MR/VR rendering 125 is provided, the user 122 may review or inspect the displayed internal components or features of the example axle and brake assembly 126 for a source of the potential problem or for purposes of inspection. Consider for example, that upon review of the internal components or features of the axle and brake assembly 126, illustrated in the updated AR/MR/VR rendering 125, one or more brake pads in the set of brake pads 139 are color coded or otherwise indicated as potentially requiring replacement. In response, the user 122 may select the rendering of the set of brake pads 139 in the updated AR/MR/VR rendering 125 to provide an additional updated AR/MR/VR rendering 137, as illustrated in the display of the handheld device view 120-3.

In the illustrated handheld device view 120-3, the AR/MR/VR rendering 137 shows a cross-section view of the set of brake pads 139. A sensor 140 is illustrated that may be associated with each brake pad for determining the thickness of individual brake pads where the thickness may be used as an indicator of brake pad health. According to examples, as described above, each brake pad of the set of brake pads 139 may be color coded or otherwise indicated to show the health of the individual brake pads comprising the set of brake pads 139. For example, brake pad 142 may be color coded or otherwise indicated as requiring immediate replacement. Brake pad 144 may be color coded or otherwise indicated as being acceptable for continued use. Brake pad 146 may be color coded or otherwise indicated as being good and not requiring any maintenance action. Thus, if the user 122 first initiated a review of the example brake assembly 126 owing to a noise or squeak emanating from the axle and brake assembly 126, the user 122 may determine that the problem is being caused by the brake pad 142 color coded or otherwise indicated as requiring immediate replacement. As will be described below, the ROM-based AR/MR/VR renderings of components of the work machine 100 may be used for directing maintenance of one or more components, for periodic inspection purposes, for training work machine operators and maintenance personnel, and/or for fleet management.

FIG. 2 illustrates a system 200 for generating a ROM-based digital twin of an equipment system, subsystem, or component and for utilizing augmented reality, mixed reality, or virtual reality for providing review of and interaction with a presentation of an equipment system, subsystem, or component, according to examples of the present disclosure. According to examples, data of various types is passed to a reduced order model (ROM) system 212 where a ROM model is generated for components of the work machine 100. As described herein, the ROM model generated by the ROM system 212 may be enhanced or tuned by information processed by a machine learning model 216. The ROM model generated and tuned (as desired) may then be passed to a digital twin model system 220 where a digital twin 224 of the work machine 100 may be generated. In addition, the digital twin 224 may be utilized by an AR/MR/VR system 228 for generating the AR/MR/VR renderings 124, 125, 137 illustrated and described above with reference to FIG. 1.

Referring still to FIG. 2, data passed from the work machine 100 to the ROM system 212 includes system data 204 and operating conditions data 208. According to examples, system data 204 may include data representing each component or selected components of the work machine 100 including physical dimensions, locations in the work machine, operating data (power requirements, power systems, electrical systems, hydraulic systems, pneumatic systems, etc.) relationships of one component to another component, and the like. In addition, all system data contained in work machine user manuals, parts manuals, repair and maintenance documentation including repair and maintenance historical data, and the like may be passed to the ROM system 212. That is, all system data 204 necessary for enabling the ROM system 212 to generate a reduced order model for the work machine 100 and associated components with which a digital twin 224 may be generated is passed to the ROM system 212.

As should be appreciated, system data 204 for the work machine 100 may be identical for all work machines 100 of a same model at the time of manufacture. However, as soon as a given work machine 100 is placed into service, use of the work machine 100 in varying ways (e.g., varying speeds, varying terrains, varying workloads, varying operating durations, etc.) in varying operating conditions may cause ROM modeling for one work machine 100 to differ from ROM modeling for another work machine 100. Thus, in order to individualize ROM modeling for each work machine 100, operating conditions data 208 for each individual work machine 100 is passed to the ROM system 212 so that a resulting ROM model for a given work machine 100 is generated based not only on the system data 204 for the work machine 100, but also on the operating conditions in which the work machine 100 operates.

According to examples, the work machine 100 may include an electronic control module (ECM) 202 that may pass operating conditions data for a work machine 100 to the ROM system 212. According to examples, the ECM 202 may include an onboard computer that controls electrical systems of the work machine 100 and that monitors, analyzes and diagnoses problems associated with the work machine 100 performance. The ECM 202 may monitor any component of the work machine for which sensors are deployed. For example, the ECM 202 may monitor component performance and status including, but not limited to work machine speed, acceleration, deceleration, loading/unloading/pushing forces, fuel consumption, ignition timing, battery charge levels, tire pressure, hydraulic and pneumatic systems fluid levels and pressures, breaking force data, and the like. The ECM 202 may also monitor physical features such as thickness of brake pads, ages of components, repair and maintenance histories, etc. In addition to monitoring such operating conditions data 208, the ECM 202 may perform diagnostics that may be provided to the ROM system 212, to the machine learning model 216 (described below) and/or to maintenance personnel.

According to examples, engineering personnel, maintenance personnel, fleet management personnel and the like may determine a set of specific components of the work machine 100 for which data will be sent to and processed by the ROM system 212. For example, components such as certain engine components, transmission systems, electrical systems, braking systems, hydraulic systems, pneumatic systems, and the like may be designated for sending data to the ROM system 212. For a given work machine 100, it may be determined that only those components for which component information is readily available owing to specific measurable component lifespans or the availability of sensor data may be processed by the ROM system 212 for generation of a digital twin and associated AR/MR/VR renderings. That is, according to examples, system data passed or transmitted to the ROM system 212 or cloud-based analysis system 308, described below, may include system data for one or more components of the work machine for which component health data (e.g., based on specified component lifespan or sensor data) is available. Other components or features of the work machine 100 may be inspected manually, or data from other components or features may be reported to personnel separately from generation of a digital twin and associated AR/MR/VR renderings, for example, via an edge device or other reporting functionality as described below with reference to FIG. 3.

Referring still to FIG. 2, the reduced order model (ROM) system 212 may include sufficient computer-executable instructions for generating a ROM model for the work machine 100. As known by those skilled in the art, reduced order modeling includes, among other things, lowering the computational complexity of large data sets and dynamic systems and is particularly useful in generating simulations of such large data sets and dynamic systems. By lowering the computational complexity of modeling such large data sets and dynamic systems, a reduced order model (ROM) may be generated that approximates a model that considers all data of the large data set and dynamic systems. According to examples of the present disclosure, the system data 204 and the operating conditions data 208 described above represents such a large data set and dynamic system for which a non-reduced order model may be computationally difficult and time-consuming requiring significant computing resources.

According to examples, the ROM model generated for the system data 204 and operating conditions data 208 is, according to reduced order modeling, simplified which means some data points of the overall data set of the system data 204 and operating conditions data 208 will not be included in a resulting ROM model. However, use of a simplified model generated by the ROM system 212 allows for updating the ROM model efficiently and on-the-fly as changes in the system data 204 and operating conditions data 208 are received from the work machine 100. That is, by reducing the computational complexity of the ROM model using reduced order modeling, the ROM model may be continuously updated so that AR/MR/VR renderings 124, 125, 137 (FIG. 1) may be updated as the system data 204 and operating conditions dated 208 changes.

In order to ensure the ROM model for the work machine 100 accurately represents the work machine 100 and its associated components, the ROM model may be validated against a non-reduced order model generated for the work machine. That is, a model may be generated for the work machine 100 based on system data 204 without using reduced order modeling, and the resulting model may be compared with a ROM model generated for the work machine 100. If variance between the two models is only attributed to those aspects of the work machine 100 system data 204 that are reduced as desired where the reduced data items are not needed for the desired digital twin 224 and AR/MR/VR renderings, then the ROM model for the work machine 100 may be considered validated for use in the system 200.

Referring still to FIG. 2, once the ROM model for the work machine 100 is generated by the ROM system 212 is validated for use, the ROM model may be updated as system data 204 changes and as operating conditions data 208 change. For example, as components of the work machine 100 change, for example, as sensors, such as the brake pad sensor 140, indicate that a component is wearing, updated sensor information for the component may be passed to the ROM system 212 as system data 204. Similarly, as operating conditions change, for example, as a work machine 100 is accelerated, braked, placed under loading, and the like, changes in such operating conditions may be passed to the ROM system 212 as operating conditions data 208.

As the ROM system 212 receives such updated data, the ROM model generated for the work machine 100 may be updated, and the digital twin 224 and AR/MR/VR renderings 124, 125, 137 for components of the work machine affected by the updated ROM model may be updated. Referring still to FIG. 2, according to examples, in addition to passing operating conditions data 2082 the ROM system 212, changes in operating conditions data 208 may be passed to a machine learning model 216. As understood by those skilled in the art, machine learning systems are trained with large amounts of data including relationships (e.g., statistical relationships) between and among data items to identify patterns of data items. With each addition of data to machine learning systems, the machine learning systems improve their ability to identify relationships and patterns between and among data items. According to examples of the present disclosure, operating conditions data 208 may be fed into the machine learning model 216, and the machine learning model 216 may learn patterns and relationships between and among operating conditions data 208 associated with the work machine 100.

As illustrated in FIG. 2, information from the machine learning model 216 may be passed to the ROM system 212 for updating or enhancing the ROM model generated for the work machine 100. For example, if operating conditions data 208 indicate that for a given work machine 100 operation, extensive braking follows acceleration of the work machine after a load of material is picked up, the machine learning model 216 may learn that excessive brake pad wear occurs after periods of braking following acceleration. Such a learned pattern may be passed to the ROM system 212 for updating a subsequently generated ROM model for the work machine 100. An AR/MR/VR rendering generated for a work machine 100 braking system may be used for inspecting the braking system as described with reference to FIG. 1 and/or for training work machine operators as to best braking and acceleration practices to reduce wear of brake pads.

Referring still to FIG. 2, as the ROM system 212 generates updated ROM models for the work machine 100 based on received system data 204, operating conditions data 208 and information from the machine learning model 216, each updated ROM model for the work machine 100 is passed to the digital twin model system 220 for generation of a digital twin 224 of the work machine 100. According to examples, the digital twin model system 220 includes sufficient computer-executable instructions for generating a digital twin 224 for the work machine 100 including digital twins for each of the components of the work machine 100 for which system data 204 and operating conditions data 208 are passed to the ROM system 212. As known by those skilled in the art, a digital twin is a virtual representation of a physical object or system that is generated by simulating the features of the physical object or system based on data describing the physical object or system.

According to examples of the present disclosure, the digital twin model system 220 may generate a digital twin 224 of the work machine 100 based on data describing the components of the work machine 100 received from a ROM model generated by the ROM system 212 representing the work machine 100 and its various components. Because simulation generated by the digital twin model system 220 is computationally difficult and expensive, use of a ROM model describing the work machine 100 enables the digital twin model system 220 to generate the digital twin 224 of the work machine 100 based on system data 204, operating conditions data 208 and machine learning model 216 information received by the ROM system 212. In addition, information from the machine learning model 216 may be passed directly to the digital twin model system 220 to assist the digital twin model system 220 in decision-making during the process of simulating the components of the work machine 100. In addition to simulating the components of the work machine 100 for generation of the digital twin 224, the digital twin model system 220 may analyze the data received via the ROM model and machine learning model to develop component insights including prediction of component performance, wear and tear, and failure.

Referring still to FIG. 2, an augmented reality/mixed reality/virtual reality (AR/MR/VR) system 228 is illustrative of a system including sufficient computer-executable instructions for enabling AR/MR/VR renderings 124, 125, 137 as described above with reference to FIG. 1. As described, by providing AR/MR/VR renderings from generation of a digital twin 224 for the work machine 100, work machine operators, operator trainers, maintenance personnel and/or fleet management personnel may enjoy a more immersive experience by reviewing virtual representations (AR/MR/VR renderings) of components of the work machine 100.

FIG. 3 illustrates an architecture for utilization of a ROM-based digital twin, according to examples of the present disclosure. In FIG. 3, a use case 300 for the ROM-based digital twin system, described herein, is provided. According to examples, work machines 100 are often utilized at worksites remote from maintenance personnel and fleet management personnel. In such cases, system data 204 and operating conditions data 208 including real time operating conditions data 208 for the work machine 100 may be passed to the ROM system 212 and digital twin model system 220 from the remote worksite so that the resulting digital twin and associated AR/MR/VR renderings may be generated and utilized by personnel remote from the work machine 100. Referring then to FIG. 3, system data 204 and real time operating conditions data 208 may be passed to a cloud-based analysis system 308 for processing as described above with reference to FIG. 2.

According to examples, the system data 204 and operating conditions data 208 may be transmitted by wireless transmission from the work machine 100 to the cloud-based analysis system 308 in the form of telematics data 304. As understood by those skilled in the art, telematics data may include data retrieved from a device or system (e.g., the work machine 100, including the ECM 202) from device or system sensors and other information gathering means for use in review, inspection, diagnostics, and status reporting for the device or system. According to examples of the present disclosure, the telematics data 304 may include the system data 204, operating conditions data 208 described above with reference to FIG. 2, as well as information from the work machine such as location, speed, travel direction, acceleration, deceleration, braking, and the like.

The cloud-based analysis system 308 may include a number of systems associated with operation of the work machine 100, including maintenance information systems, fleet management systems, personnel management systems, and the like. According to examples of the present disclosure, the system 200, illustrated and described above with reference to FIG. 2, may be included in the cloud-based analysis system 308 for generating and updating a ROM model for the work machine 100 and for generating a digital twin 224 and associated AR/MR/VR renderings 124, 125, 137 of one or more components of the work machine 100, as described herein.

According to one example, real time data 306, including system data 204 and operating conditions dated 208, as well as any other data associated with the work machine 100 provided by the work machine 100 sensors and systems (e.g., the ECM 202) also may be passed from the work machine 100 to an edge device 310. As understood by those skilled in the art, edge devices 310 may include computing devices that operate between physical environments (e.g., the work machine 100) and one or more digital processes. Edge devices 310 may be used for monitoring systems such as machinery (in this case, the work machine 100) and for routing information between networks. According to examples of the present disclosure, the edge device 310 may receive system data 204 and operating conditions data 208 from the work machine 100 before passing the system data 204 and operating conditions data 208 to the cloud-based analysis system 308, as described above.

The edge device 310 may also include sufficient computer-executable instructions for processing data received from the work machine 100 that may be separate from processing system data 204 and operating conditions data 208 at the cloud-based analysis system 308. For example, the edge device 310 may receive and process various system and environmental data items that may not be needed or utilized by the ROM system 212 and digital twin model system 220 such as weather conditions, terrain features or work machine data not utilized by the ROM system 212, and like. After such data is received and processed by the edge device 310, real time insights 314 developed by the edge device 310 may be passed to remote systems and personnel, as described below. As illustrated in FIG. 3, according to examples, real time insights 314 generated by the edge device 310 also may be passed to the cloud-based analysis system 308 for enhancing the ROM model generated for the work machine 100, as described above with reference to FIG. 2. Alternatively, the real-time insights 314 may be passed from the edge device 310 directly to remote personnel and systems, as described below.

Referring still to FIG. 3, the ROM-based digital twin 224 and associated AR/MR/VR renderings 124, 125, 137 generated at the cloud-based analysis system 308 and real-time insights 314 generated by the edge device 310 may be passed to remote personnel and systems for use in managing the work machine 100. According to one example, the digital twin 224 and associated AR/MR/VR renderings 124, 125, 137 and/or real-time insights 314 from the edge device 310 may be passed to a remote support and collaboration system 316. According to this example, the remote support and collaboration system 316 may include personnel and systems for supporting and assisting with work machine operations. For example, based on the received digital twin 214 and associated AR/MR/VR renderings 124, 125, 137, personnel and systems of the remote support and collaboration system 316 may analyze operation of the work machine 100 including component operations, component wear and tear, and component failure. Based on such analysis, remote personnel may advise operators of the work machine 100 on component maintenance needs, as well as best practices for work machine operation. If maintenance actions are needed, maintenance personnel may be dispatched to a site of the work machine 100. Based on the received digital twin 224 and associated AR/MR/VR renderings 124, 125, 137, maintenance personnel may know in advance parts and particular personnel needed at the site of the work machine 100 before starting maintenance actions.

Referring still to FIG. 3, the digital twin 224 and associated AR/MR/VR renderings 124, 125, 137 provided to maintenance personnel also will allow enhanced inspection systems 324 to be utilized as part of maintenance actions. That is, without the need to disassemble or “tear down” components of the work machine 100, maintenance personnel may perform virtual inspections of components of the work machine 100 prior to beginning maintenance actions. In addition, receipt of the digital twin 224 and associated AR/MR/VR renderings 124, 125, 137 for the work machine 100 may allow fleet management personnel to determine needs for additional fleet resources at a work site of the work machine 100. For example, if information received by fleet management personnel 318 indicates the work machine 100 may be taken offline for maintenance or repair, the fleet management personnel 318 may make fleet decisions without the need to visit the work site of the work machine 100.

Referring still to FIG. 3, in addition to the foregoing, the digital twin 214 and associated AR/MR/VR renderings 124, 125, 137 for various components of the work machine 100 may be presented to an operator of the work machine 100 via onboard systems 320 in the work machine 100. Thus, before or simultaneous with reporting of the digital twin 224 and associated AR/MR/VR renderings to remote personnel, an operator of the work machine 100 may receive such information via onboard systems 320. Based on such information, the operator may be able to determine maintenance needs of the work machine 100 that may be processed locally without the need for involving remote personnel and systems.

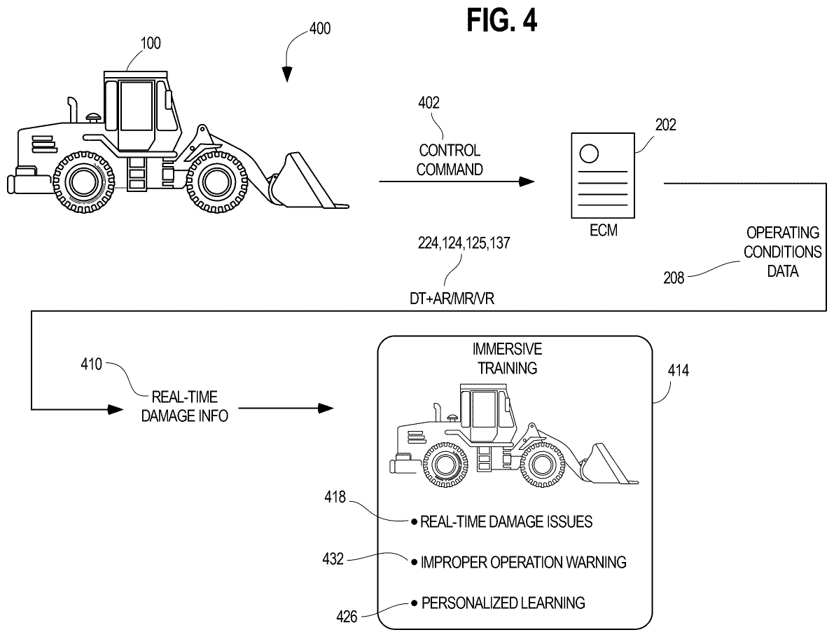

FIG. 4 illustrates use of ROM-based digital twins 224 and associated AR/MR/VR renderings 124, 125, 137 for immersive training for operators of the work machine 100 for preventing or managing damage to components of the work machine 100. As illustrated in FIG. 4, when an operator of the work machine 100 conducts a control command 402 that results in damage to a work machine component, real time damage information 410 may be used for providing immersive training to the operator. For example, consider that an operator accelerates the work machine 100 into a mound of dirt or other material and a hydraulic pump that controls the work tool 118 (e.g., bucket-see FIG. 1) of the work machine 100 begins to fail. According to examples of the present disclosure, the ECM 202 may sense and report the failing hydraulic pump to the ROM system 212 as part of the system data 204 or real time operating conditions data 208. In addition, information on operating conditions, including acceleration of the work machine 100 and loading forces on the work tool 118 as sensed by the associated hydraulic system may be reported to the ROM system 212 as part of operating conditions data 208. In addition, the operating conditions data 208 associated with the operation may be passed to the machine learning model 216 which may, in turn, pass learned information from the received data associated with the operation to the ROM system 212.

In response, the ROM system 212 may update the ROM model for the work machine 100, and an updated digital twin 224 and associated AR/MR/VR renderings for the subject hydraulic pump, including any real time damage information 410, may be generated and passed to remote systems and services, as described above with reference to FIG. 3. According to examples, the operator may be asked to engage in an immersive training station 414 with operator training personnel or maintenance personnel. During an operator training session, the operator of the work machine 100 may be presented with the AR/MR/VR renderings 124, 125, 137 for the damaged or failing hydraulic pump along with operating conditions data 208 that were occurring during the damage or failure to/of the subject hydraulic pump. The operator of the work machine may then be alerted to the real time damage issues 418 associated with the event to let the operator understand the result of her/his use of the work machine 100. The operator may then be presented with an improper operation feedback or warning 432 let the operator know that her/his operation of the work machine 100 was improper. In addition, the operator may receive personalized training 426 about best practices for operating the work machine 100 in the circumstances encountered by the operator of the work machine 100.

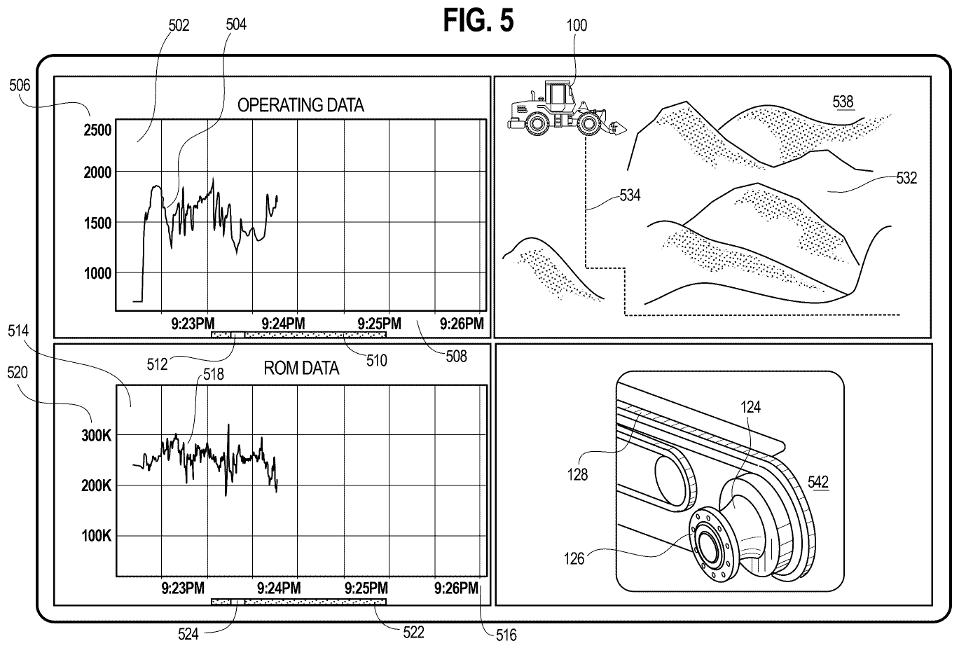

FIG. 5 illustrates both historical and real time data associated with operation of the work machine 100. According to examples, the data and images illustrated FIG. 5 may be available on board the work machine 100 or may be passed to remote management personnel as described above with reference to FIG. 3. As illustrated in FIG. 5, a plot 538 in the upper right corner of the screen presentation shows terrain 532 encountered by the work machine 100 during a prescribed work period. A route 534 is illustrated as taken by the work machine 100 during the prescribed work period.

In the lower right corner of the screen presentation, an AR/MR/VR rendering 124 of a work machine component associated with the data presented in the screen presentation is provided. As should be appreciated, the data presented in the screen presentation of FIG. 5 may be associated with a given component of the work machine 100. According to this example, the axle and brake assembly 126, described above with reference to FIG. 1, has been selected for presenting operational data in the screen presentation of FIG. 5. If another component is selected, an AR/MR/VR rendering for the other component may be presented along with data associated with the other component.

The two graphs 502, 514 illustrated on the left side of the screen presentation illustrated in FIG. 5 may show data associated with operating the work machine over the course of the prescribed work period. For example, the top left graph 502 may show engine speed (e.g., rounds per minute (RPM)) 506 over the course of the example work period. (e.g., 9:23 PM to 9:24 PM). The lower left graph 514 may show ROM calculation cycles 524 for the example axle and brake assembly 126 during the example work period. Slider bars 510, 512 and 522, 524 may be utilized for adjusting the graph presentations to show work machine data during other work periods. As should be appreciated, other graphs may be presented as desired, for example, graphs associated with other components and other operating attributes such as acceleration/deceleration over prescribed work periods, loading forces over prescribed work periods, and the like.

As should be appreciated, the information illustrated in FIG. 5 is for purposes of example only and is not limiting of corresponding information that may be provided for any component of the work machine 100. That is, as the graphs, plots, and data illustrated in the screen presentation of FIG. 5 are associated with the component illustrated by the AR/MR/VR rendering 124 in the lower right corner. The component of interest may be automatically presented along with associated operating plots 538 and graphs 502, 514 when a problem arises with particular component. Alternatively, the information presented in FIG. 5 may be presented in response to selection of a given work machine 100 component for review or inspection.

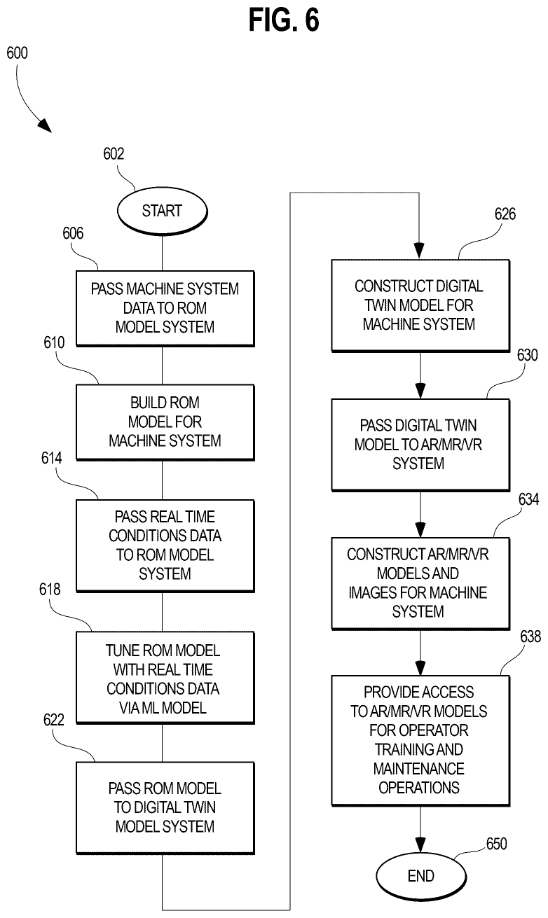

FIG. 6 illustrates a flow diagram of an example method for generation and utilization of a ROM-based digital twin of an equipment system, subsystem, or component, according to examples of the present disclosure. The method 600 begins at operation 602 and proceeds to operation 606 where system data 204 is passed from a work machine 100 to the ROM system 212. As described herein, the system data 204 may include a variety of data covering the various components of the work machine 100, including data passed to the ROM system 212 from the ECM 202 of the work machine 100. As described above with reference to FIG. 3, the system data 204 may be passed to the ROM system 212 via telematics data 304 to the ROM system 212 at the cloud-based analysis system 308.

At operation 610, a ROM model for the work machine 100 is built for the work machine at the ROM system 212. At operation 614, real time operating conditions data 208 may be passed to the ROM system 212 and machine learning model 216. When the real time operating conditions data 208 is received at the ROM system 212, the ROM model for the work machine 100 may be updated based on the real time operating conditions data 208.

At the machine learning model 216, the real time operating conditions data 208 is used to train the machine learning model. At operation 618, learned data patterns and relationships associated with the received real time operating conditions data 208 may be passed to the ROM system 212 to tune or update the ROM model built for the work machine 100.

At operation 622, the ROM model (including updates) is passed to the digital twin model system 220. At operation 626, a digital twin 224 for the work machine 100 is constructed including digital twins for various components of the work machine 100.

At operation 630, the digital twin 224 for the work machine 100 is passed to the AR/MR/VR system 228. At operation 634, interactive AR/MR/VR renderings 124, 125, 137 for the work machine 100 including renderings for various components of the work machine 100 are constructed.

At operation 638, access to AR/MR/VR renderings are provided to a machine operator, operator trainers, maintenance personnel and fleet management personnel as described herein. The method 600 ends at operation 650.

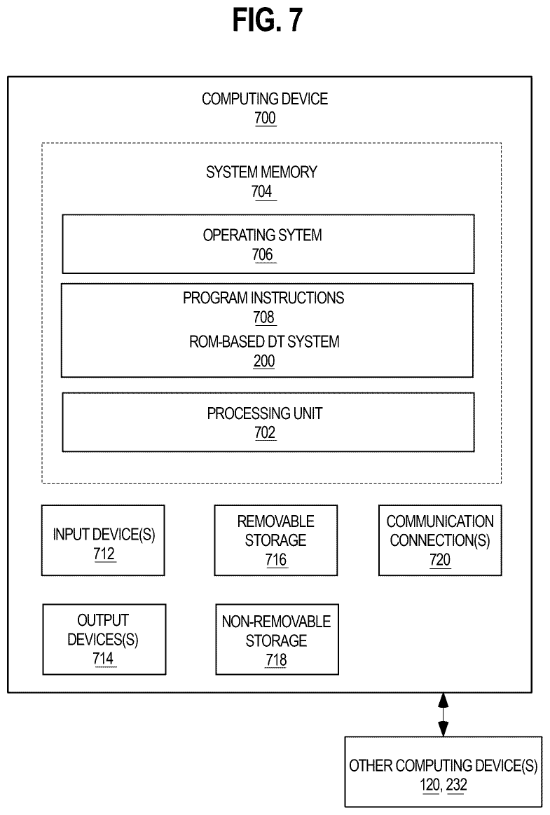

FIG. 7 is a block diagram illustrating physical components of an example computing device with which examples of the present disclosure may be practiced. The computing system 700 may include at least one processing unit 702 and the system memory 704. The system memory 704 may comprise, but is not limited to, volatile (e.g., random access memory (RAM)), non-volatile (e.g., read only memory (ROM)), flash memory, or any combination thereof. System memory 704 may include an operating system 706, one or more program instructions 708, and may include sufficient computer-executable instructions for operating the ROM-based digital twin and AR/MR/VR system 200, described herein. Operating system 706, for example, may be suitable for controlling the operation of the computing system 700. Furthermore, examples may be practiced in conjunction with a graphics library, other operating systems, or other application programs and is not limited to any application or system. This basic configuration is illustrated by those components within a dashed line 710. The computing system 700 may also include one or more input device(s) 712 (e.g., keyboard, mouse, pen, touch input device, etc.) and one or more output device(s) 714 (e.g., display, speakers, printers, etc.).

The computing system 700 may also include additional data storage devices (removable or non-removable) such as, for example, magnetic discs, optical discs, or tape. Such additional storage is illustrated by removable storage 716 and a nonremovable storage 718. The computing system 700 may also contain a communication connection 720 that may allow the computing system 700 to communicate with other computing devices 722 such as over a network in a distributed computing environment, for example, an intranet or the Internet. The communication connection 720 is an example of a communication medium, via which computer-readable transmission media (i.e., signals) may be propagated.

Program modules may include routines, programs, components, data structures, and other structures that may perform tasks or that may implement abstract data types. Moreover, examples may be practiced with other computer system configurations, including hand-held devices, multiprocessor systems, microprocessor-based or programmable user electronics, minicomputers, mainframe computers, and the like. Examples may also be practiced in distributed computing environments where tasks are performed by remote computing and processing devices that are linked through a communications network. In a distributed computing environment, programming modules may be in both local and remote memory storage devices. Furthermore, examples may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SOC)). Examples may also be practiced using other technologies capable of performing logical operations such as, for example, AND, OR, and NOT, including but not limited to mechanical, optical, fluidic, and quantum technologies. In addition, examples may be practiced within a general-purpose computer or in other circuits or systems.

Examples may be implemented as a computer process (method), a computing system, or as an article of manufacture, such as a computer program product or computer-readable storage medium. The computer program product may be a computer storage medium readable by a computer system and encoding a computer program with instructions for executing a computer process. Accordingly, hardware or software (including firmware, resident software, micro-code, etc.) may provide examples discussed herein. Examples may take the form of a computer program product on a computer-usable or computer-readable storage medium having computer-usable or computer-readable program code embodied in the medium for use by, or in connection with, an instruction execution system.

Examples of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented within the computing system 700 or any other computing devices 722, in combination with the computing system 700, where functionality may be brought together over a network in a distributed computing environment, for example, an intranet or the Internet to perform the functions described herein. Systems, devices, and processors described herein are provided as examples; however, other systems, devices, and processors may comprise the memory storage and processing unit, consistent with the described disclosure.

### INDUSTRIAL APPLICABILITY

Systems and methods provide for leveraging digital twin generation, artificial intelligence and machine learning analytics, and immersive augmented reality, mixed reality, or virtual reality experiences. As such, a more realistic virtual maintenance, fleet management, and training environment is enabled. According to examples, equipment operators, operator training personnel, maintenance personnel, and fleet management personnel may visualize equipment systems, subsystems and components for maintenance, repair, training, and fleet management without the need to disassemble or “tear down” systems, subsystems, or components.

Generation of a reduced order model (ROM)-based digital twin and presentation of an equipment system, subsystem or component using augmented reality, mixed reality or virtual reality is provided. By generation of and use of a ROM-based digital twin, only those features of a given machine or piece of equipment that are needed for inspection, maintenance, training and/or fleet management are included in the digital twin because ROM modeling reduces the computational complexity of a model from which the digital twin is generated. For example, components of a machine or piece of equipment that may be inspected through simple visual inspection, for example, a flat tire, broken window glass, exterior steel component and the like do not need to be included in the ROM model used for generation of the digital twin. Thus, computational costs, speed of digital twin generation and data requirements are reduced.

A reduced order model (ROM) may be generated for each desired component of a work machine. The ROM model may be initially generated based on specifications of the work machine including detailed information on each component of the work machine. The initially generated ROM model may be enhanced by feeding the ROM model real-time component data such as received from internal sensors associated with work machine components and by feeding the ROM model with real-time operating conditions such as work machine speed, acceleration, deceleration, braking, work machine loading data, work machine operating terrain, work machine material handling information, as well as environmental conditions such as temperature, wind velocity, moisture presence, and the like. Information used for enhancing or tuning an initially generated ROM model may be fed directly to the ROM model or may be processed by a machine learning and artificial intelligence system that, in turn, may feed information to enhance the ROM model to a ROM model system.

After generation of an initial ROM model and/or after enhancement or tuning of the initial ROM model with real-time information, a digital twin of the work machine and its components may be generated. An augmented reality (AR), mixed reality (MR) or virtual reality (VR) rendering may be generated from the digital twin for the work machine and for each of its included components. Operators of the work machine, operator training personnel, maintenance personnel, and/or fleet management personnel may utilize the AR/MR/VR renderings of the components of the work machine for determining problems with components of the work machine, for predicting future problems with components of the work machine, for training operators of the work machine, for assisting maintenance personnel, and for assisting in management of work machine fleets.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A method, comprising:
receiving system data from a work machine, the system data associated with one or more components of the work machine for which component health data is available;
passing the system data to a reduced order model system;
at the reduced order model system, generating a reduced order model for the one or more components of the work machine;
passing the reduced order model for the work machine to a digital twin model system;
at the digital twin model system, generating a digital twin for the one or more components of the work machine; and
generating from the digital twin an augmented reality rendering of the one or more components of the work machine.

2. The method of claim 1, further comprising receiving a selection of
an augmented reality rendering for one of the one or more components; and
receiving an augmented reality rendering of a subcomponent of the one of the one or more components of the work machine.

3. The method of claim 1, further comprising applying a health indicator to one or more features of the augmented reality rendering.

4. The method of claim 3, wherein applying a health indicator to one or more features of the augmented reality rendering includes color-coding the one or more features of the augmented reality rendering.

5. The method of claim 1, prior to generating from the digital twin an augmented reality rendering of one or more components of the work machine, further comprising receiving a request for an augmented reality rendering of the one or more components of the work machine.

6. The method of claim 5, wherein receiving a request for an augmented reality rendering of the one or more components of the work machine includes receiving an identification of the one or more components of the work machine.

7. The method of claim 5, wherein in response to receiving a request for an augmented reality rendering of the one or more components of the work machine, further comprising displaying the augmented reality rendering of the one or more components of the work machine.

8. The method of claim 1, further comprising:
receiving updated system data from the work machine;
passing the updated system data to the reduced order model system;
at the reduced order model system, updating the reduced order model for any of the one or more components for which updated system data is received;
passing the updated reduced order model for the work machine to the digital twin model system; and
at the digital twin model system, generating an updated digital twin for the any one or more components for which updated system data is received.

9. The method of claim 8, prior to generating an updated digital twin for the any one or more components for which updated system data is received, further comprising:
receiving real time operating conditions data for the work machine; and
passing the real time operating conditions data for the work machine to the reduced order model system.

10. A method of claim 9, further comprising:
receiving updated real time operating conditions data for the work machine,
passing the updated real time operating conditions data for the work machine to the reduced order model system;
at the reduced order model system, updating the reduced order model for the one or more components of the work machine.

11. The method of claim 9, further comprising:
passing the real time operating conditions data for the work machine to a machine learning model;
training the machine learning model with the real time operating conditions data;
passing information associated with the real time operating conditions data from the machine learning model to the reduced order model system; and
updating the reduced order model for the one or more components of the work machine.

12. A system, comprising:
a work machine having an electronic control module configured to pass system data and real time operating conditions data for the work machine to a reduced order model system, the reduced order model system configured to:
generate a reduced order model for the work machine based at least in part on the system data and real time operating conditions data for the work machine, and
transmit the reduced order model to a digital twin model system, the digital twin model system configured to generate a digital twin for the work machine based at least in part on the system data and real time operating conditions data for the work machine; and
an augmented reality system configured to generate from the digital twin an augmented reality rendering of a component of the work machine.

13. The system of claim 12, wherein the augmented reality system is further configured to generate an augmented reality rendering of a subcomponent of the component of the work machine in response to a selection of the augmented reality rendering of the component of the work machine.

14. The system of claim 12, wherein the augmented reality system is further configured to apply a health indicator to a feature of the augmented reality rendering.

15. The system of claim 14, wherein the augmented reality system is further configured to apply a color-coding health indicator to a feature of the augmented reality rendering.

16. A method, comprising:
transmitting system data and operating conditions data from a work machine to a cloud-based analysis system;
at the cloud-based analysis system, passing the system data and the operating conditions data to a reduced order model system;
at the reduced order model system, generating a reduced order model for the work machine;
at the cloud-based analysis system, passing the reduced order model for the work machine to a digital twin model system;
at the digital twin model system, generating a digital twin for the work machine;
at the cloud-based analysis system, passing the digital twin for the work machine to an augmented reality system; and
at the augmented reality system, generating from the digital twin an augmented reality rendering of the work machine.

17. The method of claim 16, wherein transmitting system data and operating conditions data from a work machine to a cloud-based analysis system includes transmitting system data for one or more components of the work machine for which component health data is available.

18. The method of claim 16, further comprising:
transmitting the operating conditions data from the work machine to an edge device configured to generate real time insights associated with the operating conditions data.

19. The method of claim 18, further comprising:
transmitting the augmented reality rendering of the work machine and the real time insights to a remote support and collaboration system; and
at the remote support and collaboration system, determining maintenance requirements for the work machine based at least in part on the augmented reality rendering of the work machine and the real time insights.

20. The method of claim 18, further comprising:
transmitting the augmented reality rendering of the work machine and the real time insights to an immersive training system for training work machine operations based at least in part on the augmented reality rendering of the work machine and the real time insights.
